(19) United States
(12) Patent Application Publication
(10) Pub. No.: US 2016/0357182 A1
(43) Pub. Date: Dec. 8, 2016

(54) AIRCRAFT PLANNING CONTROL SYSTEM AND METHOD

(71) Applicant: Peter Ireland, Wentworth Falls (AU)

(72) Inventor: Peter Ireland, Wentworth Falls (AU)

(21) Appl. No.: 15/175,030

(22) Filed: Jun. 6, 2016

Related U.S. Application Data
(60) Provisional application No. 62/172,041, filed on Jun. 6, 2015.

(51) Int. Cl. G05D 1/00; B64D 43/02

(52) U.S. Cl. CPC G05D 1/0005; B64D 43/02

(57) ABSTRACT

An aircraft planning control system and method. According to one embodiment, a flight management computer and remote server system are communicably coupled to a plurality of sensors, the plurality of sensors recording data associated with an aircraft in operation. The data is used by the remote server system and flight management computer to generate real-time performance data for the aircraft, and to optimize a speed schedule for the aircraft.

### BACKGROUND OF THE INVENTION

The present invention relates generally to airplane control systems and methods and more specifically to systems and methods for planning and controlling aircraft speed.

Flight planning charts and performance tables supplied by aircraft manufacturers provide only an approximation of actual aircraft performance in flight. The increasing need for fuel conservation has led to more precise methods of cruise control and performance analysis.

These flight planning charts and performance tables are used by a flight management computer (FMC) to predict a particular aircraft's speeds that are applied to that aircraft's climb, cruise, and descent for optimum trajectory. One example of a parameter included in such tables is drag polar, and the drag polar is the relationship between the lift on an aircraft and its drag, expressed in terms of the dependence of the lift coefficient on the drag coefficient.

Using aircraft manufacturer supplied information results in a problematic situation where a drag polar specific to real-time operation of a particular aircraft does not necessarily match the approximate drag polar. Most aircraft have a greater drag polar during operation than the baseline or approximate drag polar provided by the manufacturer.

When a higher drag polar than the baseline exists, what results is a shift in a drag curve upwards and to the right (on a curve of drag vs. speed). The net effect is that the aircraft is being flown at the wrong speed for absolute max performance in climb, cruise and descent.

Specifically, many airlines use a cost index system (CI, which is a factor that affects speeds by comparing the cost of fuel vs. the cost of fuel and all other aircraft and crew costs), and this results in the aircraft flying at speeds that are not optimal.

It is within the aforementioned context that a need for the present invention has arisen. Thus, there is a need to address one or more of the foregoing disadvantages of conventional systems and methods, and the present invention meets this need.

### BRIEF SUMMARY OF THE INVENTION

Various aspects of methods and systems for planning and controlling aircraft speed can be found in exemplary embodiments of the present invention.

In a first embodiment, a flight management computer and remote server system are communicably coupled to a plurality of sensors, the plurality of sensors recording data associated with an aircraft in operation. The data is used by the remote server system and flight management computer to generate real-time performance data for the aircraft, and to optimize a speed schedule for the aircraft.

With the present invention, operating cost for a specific aircraft is optimized based upon the specific aircraft's performance as opposed to approximate performance parameters provided by the aircraft's manufacturer.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates an aircraft planning control system according to an exemplary embodiment of the present invention.

FIG. 2 illustrates an aircraft performance survey process according to an exemplary embodiment of the present invention.

FIG. 3 illustrates a jet speed schedule control process according to an exemplary embodiment of the present invention.

FIG. 4 illustrates an exemplary computer architecture for use with an exemplary embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

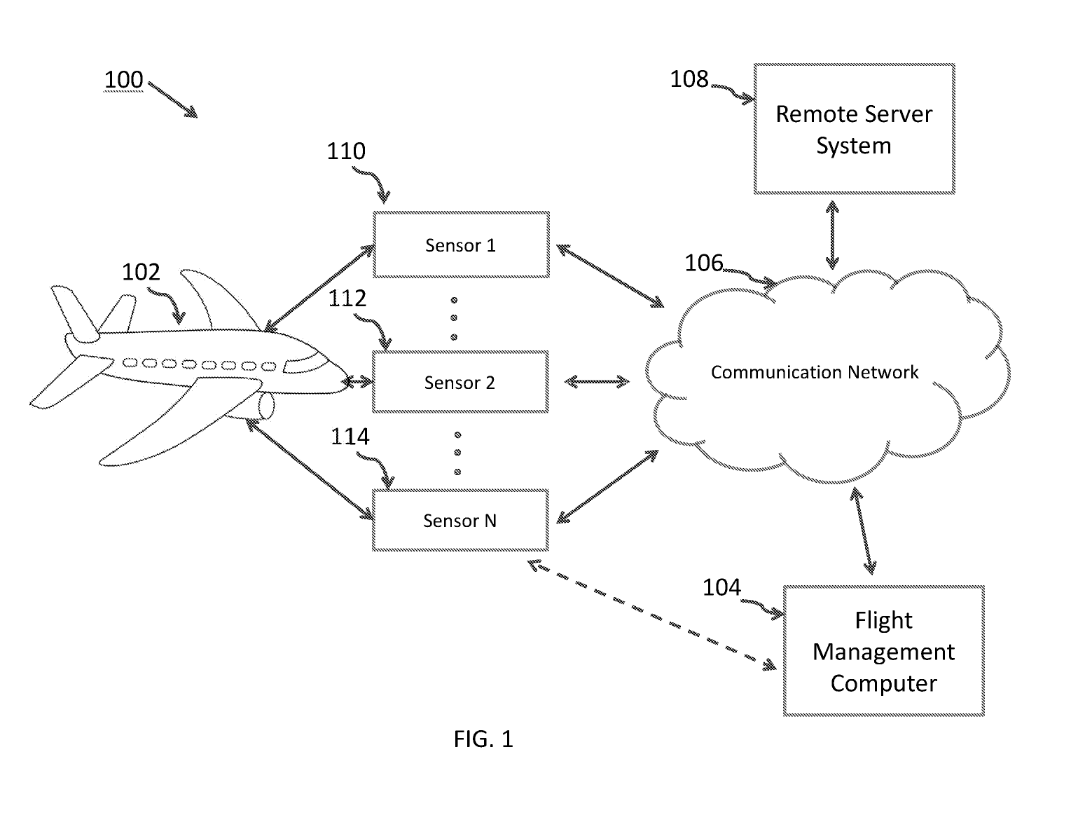

FIG. 1 illustrates an aircraft planning control system 100 according to an exemplary embodiment of the present invention.

In FIG. 1, aircraft planning control system 100 comprises an aircraft 102 having several sensors 110, 112, 114 for monitoring various aircraft parameters in real-time. A flight management computer (FMC) 104 receives data from sensors 110, 112, 114 either via Internet/communication network 106 or through some other communication connection such as a satellite. A remote server system 108 is also communicably coupled via Internet/communication network 106 to the flight management computer (FMC) and the sensors 110, 112, 114.

It will be appreciated that, while sensors 110, 112, 114 can be communicably coupled to the flight management computer 104 and remote server system 108, communication via Internet/communication network 106 can be possible but is not necessary while the aircraft 102 is in flight. Sensor data recorded by sensors 110, 112, 114 can be stored locally while the aircraft 102 is in flight and transmitted as a batch to flight management computer 104 and remote server system 108 when communication is enabled post-flight.

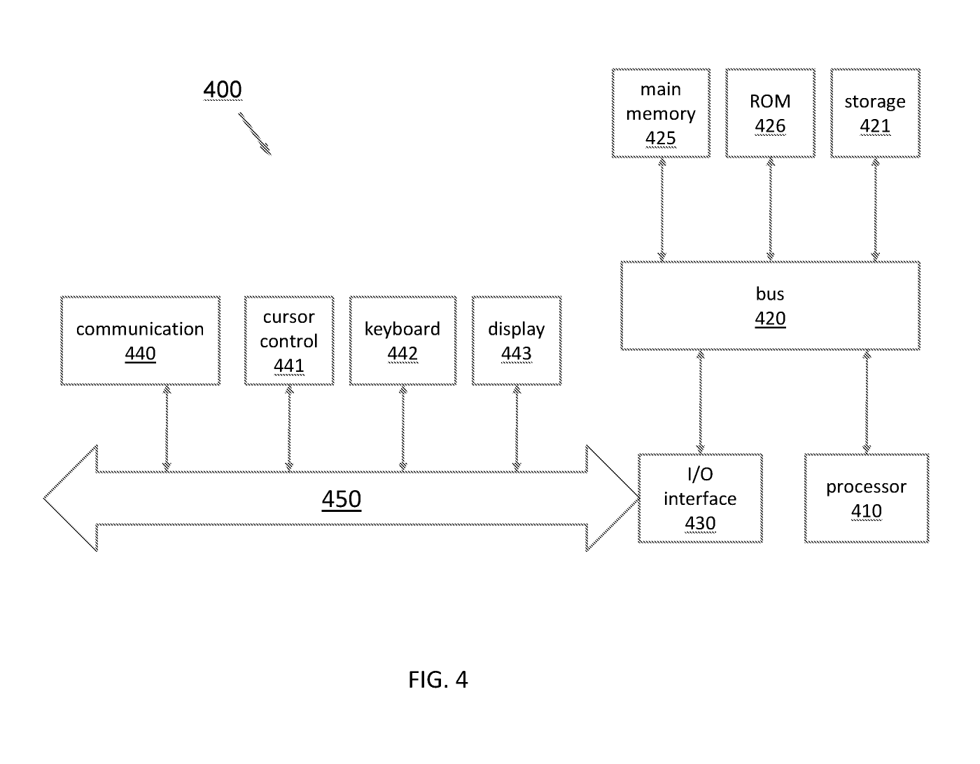

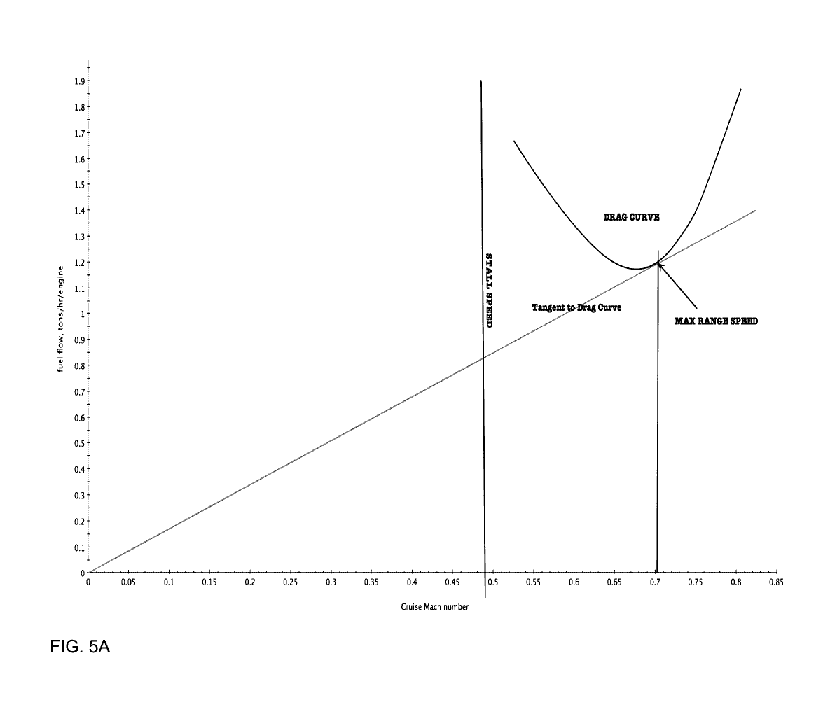

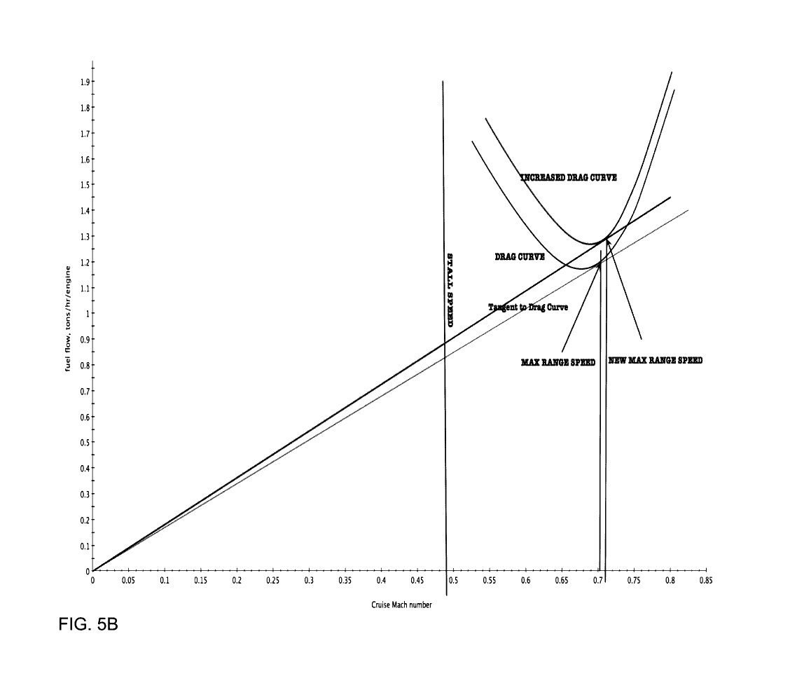

Internet/communication network 106 can be any communication network that allows data to be communicated or transferred from one point to another. Such a network might be wired or wireless as deemed necessary to be consistent with the spirit and scope of the present invention FMC 104 and remote server 108 can have architectures according to the embodiment disclosed in FIG. 4.

Flight management computer 104 and remote server system 108 are communicably coupled to the plurality of sensors 110, 112, 114. The plurality of sensors 110, 112, 114 record data associated with the aircraft 102 while in operation. The data is used by the remote server system 108 and flight management computer 104 to generate real-time performance data for the aircraft 102, and to optimize a speed schedule for the aircraft. It will be appreciated that the recorded data can be used to optimize operation of the aircraft in areas other than speed scheduling as well.

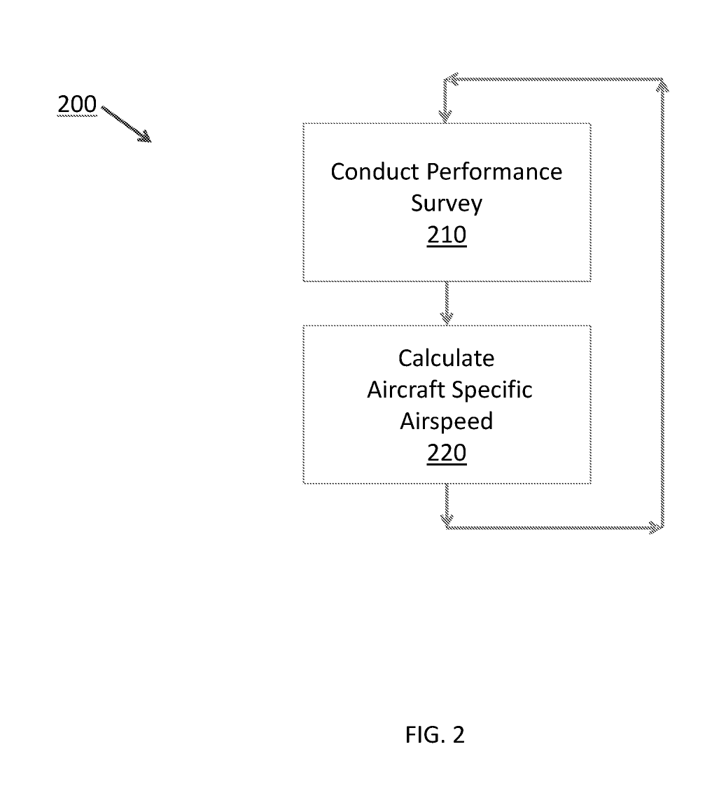

FIG. 2 illustrates an aircraft performance survey process 200 according to an exemplary embodiment of the present invention.

In FIG. 2, an aircraft performance survey process 200 is conducted to establish an offset that exists between an approximate parameter supplied by an airline manufacturer and an actual real-time parameter associated with a particular aircraft. An example of an approximate parameter is the drag polar (baseline) provided by the aircraft manufacturer, which typically varies from the real-time drag polar of the aircraft as the aircraft is in flight.

In FIG. 2, a performance survey is conducted 210 for a specific aircraft so that true airspeeds can be calculated (at 220) for the aircraft. Each calculated true airspeed is associated with one or more of a cost index, fuel flow, and drag polar.

In one embodiment, the performance survey includes conducting a speed sweep from a speed at nominally maximum range to a higher speed, which is at a cost index CI=0; the speed steps based on incremental to a speed that is the maximum cruise speed. Note For example, a speed sweep can be conducted from CI=0 through CI=200 in steps. The result of the performance survey includes the true airspeed that the specific aircraft flies for cost indexes as incremented.

In another embodiment, the performance survey includes recording fuel flow of the aircraft at different airspeeds. In yet another embodiment, the performance survey includes setting different thrust or fuel flow settings and recording the true airspeed at each of a number of thrust settings.

The performance survey 210 evaluates the aircraft's drag polar and also compares target speeds generated by the flight management computer (FMC) for a given cost index (CI) against specific fuel flow settings. This ensures that a shift from CI=0 is actually the exact maximum range speed is correctly identified.

The performance survey 210 data is normalized to known aircraft performance monitoring factors (APMS data). The known APMS data is used to establish offsets of a given aircraft from nominal performance metrics. The nominal performance metrics for a particular aircraft is provided by the manufacturer and is published in the aircraft performance planning manual (APPM) or recorded in the performance database of the FMC.

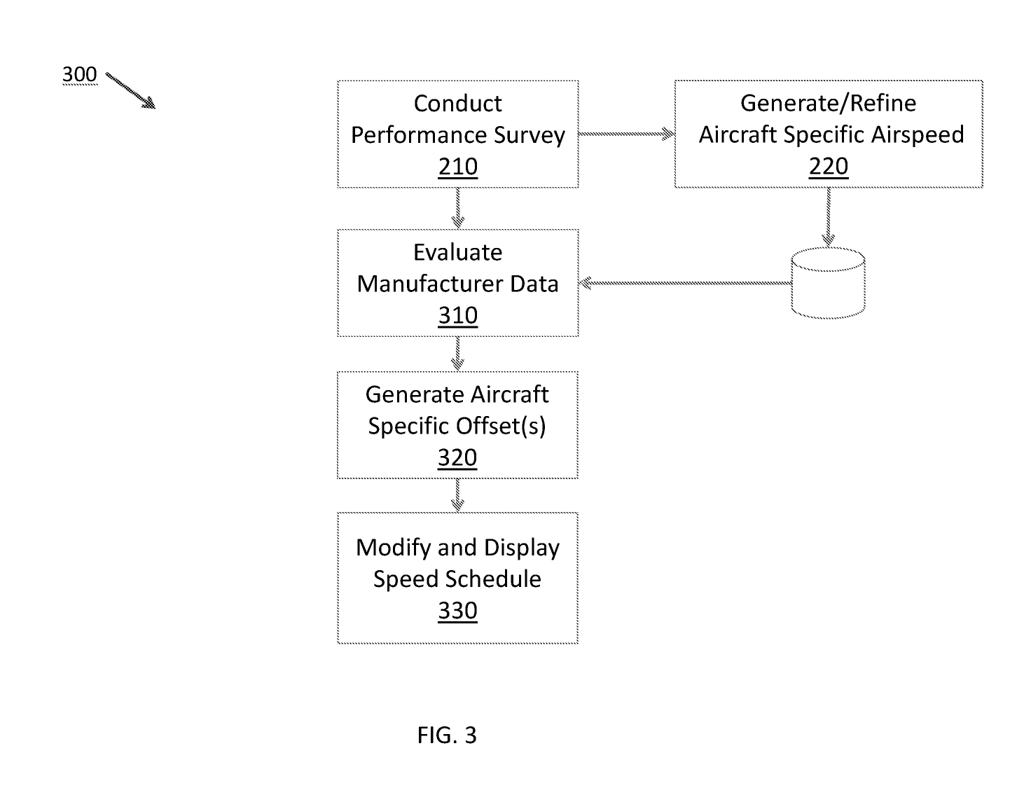

FIG. 3 illustrates a jet speed schedule control process 300 according to an exemplary embodiment of the present invention.

In FIG. 3, a jet speed schedule control process 300 relies upon the conducted performance survey 210 and resulting calculated specific airspeeds 220. The calculated airspeeds 220 are compared to the performance data provided by the manufacturer 310 in order to generate offset(s) 320 for the aircraft. The offset(s) is/are used to modify and/or display a change in speed schedule 330.

In one embodiment, modification of the speed schedule includes adding a table or parameter to a calculated optimum cost index (CI) for a particular route or fleet. Such a table or parameter provides for application of the correct performance and reduction of operating cost. The correct calculation can also be provided to the operator of an aircraft in the form of a data sheet for correction of the cost index for a particular operation.

In one embodiment, a correction algorithm is incorporated in the flight management computer. The algorithm automatically corrects speed schedules for an aircraft based on actual real-time performance calculations for the aircraft. This can be achieved by adding an offset as determined from the performance survey of the aircraft, the offset related to actual fuel consumption at various cost indexes.

As an example, consider a B777-200ER having a desired company CI of 27. A performance survey of the aircraft (e.g., speed vs. drag polar) reveals that maximum range speed is not achieved at the expected CI=0, but actually at CI=30.

In this scenario, the airline should apply an equivalent target of CI=57 (27+30) to the aircraft. Instead, the aircraft is burning fuel to go slower than the maximum range speed (i.e., wasting fuel). The difference in air range for this case is a loss of 5.4% of fuel efficiency for the flight at CI=0, instead of actually flying the correct, adjusted speed. This aircraft has a drag count of +2.8% only, so it is observable that large efficiencies can be obtained even with small drag differences from the baseline case. Such efficiencies obtained per aircraft can make a significant impact across a global fleet.

FIG. 4 illustrates an exemplary computer architecture 400 for use with an exemplary embodiment of the present invention.

The present invention comprises various computing entities that may have an architecture according to exemplary architecture 400, including flight management computers and remote server systems. One embodiment of architecture 400 comprises a system bus 420 for communicating information, and a processor 410 coupled to bus 420 for processing information. Architecture 400 further comprises a random access memory (RAM) or other dynamic storage device 425 (referred to herein as main memory), coupled to bus 420 for storing information and instructions to be executed by processor 410. Main memory 425 also may be used for storing temporary variables or other intermediate information during execution of instructions by processor 410. Architecture 400 may also include a read only memory (ROM) and/or other static storage device 426 coupled to bus 420 for storing static information and instructions used by processor 410.

A data storage device 425 such as a magnetic disk or optical disc and its corresponding drive may also be coupled to architecture 400 for storing information and instructions. Architecture 400 can also be coupled to a second I/O bus 450 via an I/O interface 430. A plurality of I/O devices may be coupled to I/O bus 450, including a display device 443, an input device (e.g., an alphanumeric input device 442 and/or a cursor control device 441).

The communication device 440 allows for access to other computers (e.g., servers or clients) via a network. The communication device 440 may comprise one or more modems, network interface cards, wireless network interfaces or other interface devices, such as those used for coupling to Ethernet, token ring, or other types of networks.

FIG. 5A shows a drag curve the gives the speed to fly for max range. Max range is Cost Index=0. Here, greatest economic efficiency is the speed where the total costs, FUEL, FIXED, VARIABLE vs SPEED are a minimum, max V/$. The drag curve is wrong for most aircraft, not the same as the Flight Management Computer, FMC data. The FMC uses the manufacturers data. It adds an increment in speed where the Cost Index is more than zero. In existing systems, the FMC speed is NOT corrected for any known change in drag predictions, the only change is that the FMC fuel remaining predictions are altered, the speed remains constant. This is true for all existing FMC's by test.

If the operation is at Cost Index=0, that should result in less efficiency for any condition of increased speed, as fuel flow will increase more than the speed increases. Testing shows that this is generally not the case, as the assumed maximum range speed, Cost Index=0, is incorrect, and generally that is due to higher drag, and that results in the max range speed provided by the FMC being slower than the real max range speed.

Many airlines normally fly faster than Cost Index=0, operating at maximum total cost efficiency speed. This may be actually the correct maximum range speed, but it will not be the correct maximum total cost efficiency speed, it will be too slow.

In summary, the method of the present disclosure operates an aircraft in flight to fly incremental speed steps in the aircraft, and measure the fuel flows, to ascertain the exact maximum range speed. This is a speed offset that can be determined in speed or in cost index units. Thereafter, this increment is added to any company evaluated cost index to ensure that the aircraft flies the correct speed.

The information can be derived automatically from the flight data, manually evaluated from the flight data, or from observations and recordings during a speed sweep. This is done over a period of time at various weights and altitudes within the normal operations of the airline, to map the correct drag curve of the specific aircraft. This information is then able to be provided to give a corrected cost index, or to provide a correction value to apply.

Another disadvantage of existing FMC's is that they do not alter target speed based on changes of the drag value entered into the maintenance pages of the FMC, it only corrects fuel predictions. The FMC of the present disclosure may be altered to incorporate an additional look up of modified drag curve data or to add an increment calculated by the operator following a survey of the exact performance of the aircraft. This can be done an algorithm correcting for a known offset, or an additional entry of offset that is added to the target speed to fly, or by a lookup table. Alternatively, a look up table for an offset of speed may be applied, or a provided value may be added to the target speed flown by the FMC or the auto throttle system.

While the above is a complete description of exemplary specific embodiments of the invention, additional embodiments are also possible. Thus, the above description should not be taken as limiting the scope of the invention.

1. A method for determining optimum speed for an aircraft that is in flight, the method comprising:
determining a real-time drag polar of the aircraft as the aircraft is operated in flight;
determining a drag polar offset between the real-time drag polar of the aircraft and a baseline drag polar that is provided as a performance specification for the aircraft;
determining a cost index that corresponds to the offset between the real-time drag polar and the baseline drag polar; and
using the determined cost index to adjust a desired operation cost index that is entered into a flight management computer FMC to operate the aircraft.

2. The method of claim 1 wherein determining a real-time drag polar of the aircraft as the aircraft is operated is by
measuring a plurality of speeds of the aircraft at a designated time or distance intervals;
for each measured speed, determining a corresponding fuel use for the speed; and correcting the target speed provided by the FMC by incorporating the information gained in the method of claim 1.

3. The method of claim 2 wherein the FMC achieves the correction in claim 2 by incorporating an offset value that is then added to the basic drag or performance polar.

4. The method of claim 2 further comprising incorporating a look up table providing offsets for weight, altitude and cost index, provided from data determined by the method of claim 1, that is then added to the basic drag or performance polar

5. The method of claim 2 wherein a flight management computer achieves the correction in claim 2 by incorporating a look up table providing speed targets for weight, altitude and cost index, provided from data determined by the method of claim 1, that is used instead of the basic manufacturers data

6. The method of claim 2 further comprising incorporating a look up table external to the flight management computer, providing speed targets for weight, altitude and cost index, provided from data determined by the method of claim 1, that is then added to the basic drag or performance polar

7. The method of claim 2 further comprising incorporating a look up table external to the flight management computer, providing speed targets for weight, altitude and cost index, provided from data determined by the method of claim 1, that is used instead of the basic manufacturers data.
